(19) United States
(12) Patent Application Publication
(10) Pub. No.: US 2017/0249685 A1
(43) Pub. Date: Aug. 31, 2017

(54) SYSTEM AND METHOD FOR COMMUNICATING WITH RETAIL CUSTOMERS WITH A SUSTAINABILITY STANDARD

(71) Applicant: Enrique Villa, Olympia, WA (US)

(72) Inventor: Enrique Villa, Olympia, WA (US)

(21) Appl. No.: 15/442,658

(22) Filed: Feb. 25, 2017

Related U.S. Application Data
(60) Provisional application No. 62/299,741, filed on Feb. 25, 2016.

(51) Int. Cl. G06Q 30/06; G06K 7/10; G06F 17/30

(52) U.S. Cl. CPC G06Q 30/0627; G06F 17/30879; G06K 7/10861

(57) ABSTRACT

A cloud computing system and method for communicating product and source information with retail customers with a sustainability standard is disclosed. The system may include a server system with a processor system, a communications interface, a communications system, an input system and an output system, the server system having access to a communications network, a memory system with an operating system, a communications module, a web browser module, a web server application which communicates product and source information with retail customers with a sustainability standard using non-transitory storage media and a website with a plurality of web pages to track and communicate product and source information with retail customers with a sustainability standard.

### CROSS-REFERENCE TO RELATED APPLICATIONS

The present application is a nonprovisional application which claims the benefit of U.S. Provisional Patent Application No. 62/299,741, filed on Feb. 25, 2016, entitled “System and Method for Communicating with Retail Customers with a Sustainability Standard,” which is incorporated herein by reference in its entirety as if fully set forth herein.

### FIELD OF INVENTION

The field of invention generally relates to communication methods between customers and retail institutions about the source of products being sold.

### BACKGROUND OF THE INVENTION

Products on sale for purchase at retail locations generally do not reveal anything beyond what is required: where a product was made (e.g. “Made in China”). Typically, there is little to no information available to the consumer about how the product was made, where the materials came from, and who the people are that physically produced the product in their hands.

Customers are demanding more and more information about the products they purchase because of an increased concern and awareness of environmental impacts to the world and the need for sustainably sourced goods and products. Hence, consumers are now more conscious about how their retail purchasing decisions can affect the world they live in. Information about a product is very important to making a purchase decision, and customers do not often have a reliable, comprehensive source of information when reading a label “Made in the USA”.

Customers are seeking information they can rely on in order to make sustainable product purchase decisions. Currently, these customers are forced to do their own research before they go shopping, or attempt to research using their mobile devices while shopping. They are also commonly dealing with imperfect information since they are not experts in the industry and they cannot completely trust the retailer to provide unbiased information related to their product purchase.

Product-specific information is not readily communicable to customers while they are shopping in retail stores today. Currently, retailers can only present information on product tags or the product itself. The amount and depth of information retailers can present to potential purchasers is thus severely limited. Some retailers attempt to solve this issue by presenting more information about products online at the retail store's website—however there is often no connection between the actual product at the store and the products displayed on the company website.

A solution is therefore needed that can provide customers the information they demand at the point of purchase in a way where they can make an informed decision based on standards that represent their values and allow them to support a sustainably sourced good or product.

### SUMMARY OF THE INVENTION

The present invention generally relates to a system and method for communicating product information with retail customers. More specifically, the present invention is a cloud computing system and method for communicating product and source information with retail customers with a sustainability standard.

The system for communicating product and source information with retail customers with a sustainability standard includes a server system a memory system and a website with a plurality of web pages to track and communicate with retail customers. The server system, which connects with a communications network, consists of a processor system, a communications interface, a communications system, and an input/output system. The memory system consists of an operating system, a communications module, a web browser module, and a web server application all of which use non-transitory storage media.

It is an object of the present invention to provide a cloud computing system and method for communicating product and source information with retail customers with a sustainability standard that makes navigation as simple as possible by focusing on the user experience.

It is an object of the present invention to provide a cloud computing system and method for communicating product and source information with retail customers with a sustainability standard that includes a native app that increases responsiveness and speed to deliver the best user experience for the user.

It is an object of the present invention to provide a cloud computing system and method for communicating product and source information with retail customers with a sustainability standard that increases security.

It is an object of the present invention to provide a cloud computing system and method for communicating product and source information with retail customers with a sustainability standard that partners with experienced mobile developers and consultants. The experienced mobile developers and consultants will have past experiences of success to build-on and will use their experience to save time, avoid failure, gain on quality and have a faster return on investment or ROI.

It is an object of the present invention to provide a cloud computing system and method for communicating product and source information with retail customers with a sustainability standard that encourages social interaction by including sharing options on social networks and the like.

It is an object of the present invention to provide a cloud computing system and method for communicating product and source information with retail customers with a sustainability standard that uses analytics to track key performance indicators and efficiently manages a mobile commerce or m-commerce project.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a system for communicating with retail customers with a sustainability standard,

FIG. 2A illustrates a block diagram of a client system,

FIG. 2B illustrates a block diagram of a server system,

FIG. 3 illustrates a diagram describing a plurality of cloud computing benefits,

FIG. 4 illustrates a diagram of an initial mobile application architecture, and

FIG. 5 illustrates a diagram of a single integrated Admin console.

FIG. 6 illustrates an overall system diagram.

FIG. 7 illustrates an artisan profile screenshot.

FIG. 8 illustrates a product page screenshot.

FIG. 9 illustrates a company profile screenshot.

FIG. 10 illustrates an about Povigy screenshot.

FIG. 11 illustrates a standards detail screenshot.

### DETAILED DESCRIPTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

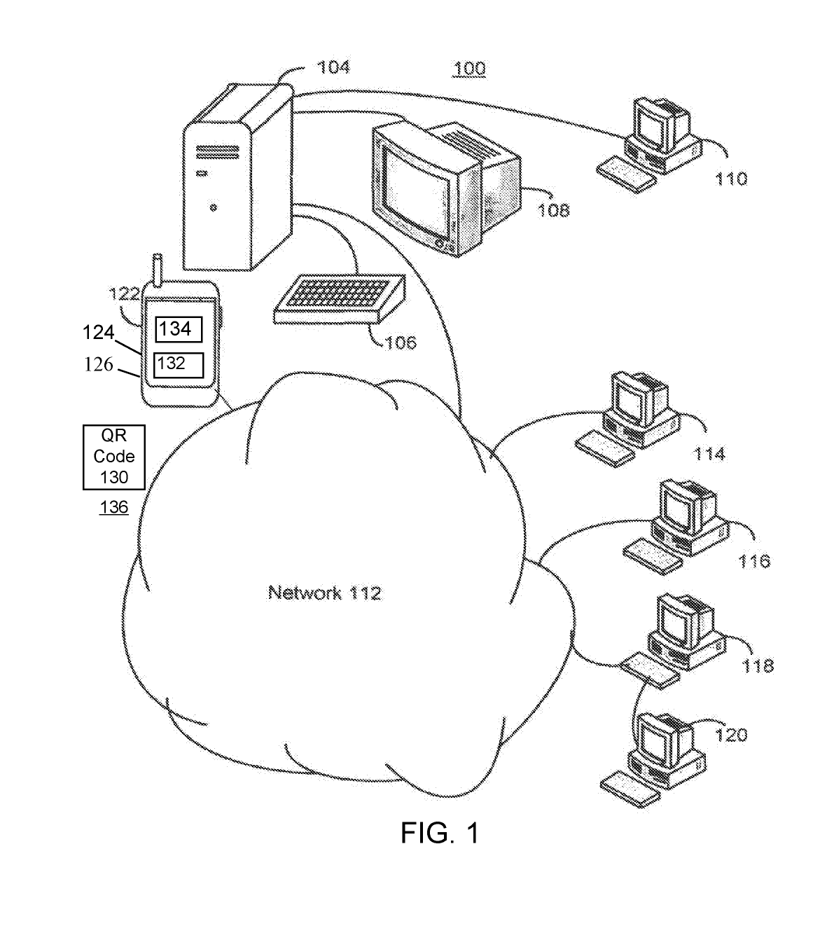

FIG. 1 illustrates a system overview of a system 100 for communicating product and source information with retail customers with a sustainability standard. The system 100 may include a server system 104, an input system 106, an output system 108, a plurality of client systems 110, 114, 116, 118 and 120, a communications network 112, a handheld or mobile device 122 and one or more quick release or QR codes 130. In other embodiments, the system 100 may include additional components and/or may not include all of the components listed above.

The server system 104 may include one or more servers. One server 104 may be the property of the distributor of any related software or non-transitory storage media or the like. In other embodiments, the system 100 may include additional components and/or may not include all of the components listed above.

The input system 106 may be utilized for entering input into the server system 104, and may include any one of, some of, any combination of, or all of a keyboard system, a mouse system, a track ball system, a track pad system, a plurality of buttons on a handheld system, a mobile system, a scanner system, a wireless receiver, a microphone system, a connection to a sound system, and/or a connection and/or an interface system to a computer system, an intranet, and/or the Internet (i.e., IrDA, USB).

The output system 108 may be utilized for receiving output from the server system 104, and may include any one of, some of, any combination of or all of a monitor system, a wireless transmitter, a handheld display system, a mobile display system, a printer system, a speaker system, a connection or an interface system to a sound system, an interface system to one or more peripheral devices and/or a connection and/or an interface system to a computer system, an intranet, and/or the Internet.

The server system 104 may be directly connected and/or wirelessly connected to the plurality of client systems 110, 114, 116, 118 and 120 and/or may be connected via the communications network 112. Client system 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals. The client systems 110, 114, 116, 118 and 120 may be any system that an end user may utilize to access the server system 104. For example, the client systems 110, 114, 116, 118 and 120 may be personal computers, workstations, laptop computers, game consoles, handheld network enabled audio/video players, mobile devices and/or any other network appliance.

The client system 120 may access the server system 104 via the combination of the communications network 112 and another system, which in this example may be the client system 118. The client system 120 may be a handheld or mobile wireless device 122, such as a mobile phone or a handheld network enabled audio/music player, which may also be utilized for accessing network content. The client system 120 may be a cell phone with an operating system or smartphone 124.

The one or more Quick Response (QR) codes 130, which are two-dimensional matrixes of black and white pixels that store information in a compact and optically scannable form, may be utilized by a mobile application. These properties facilitate the use of the one or more QR codes 130 to convey information to users. In additional embodiments, the QR codes could be various types of technologies that allow users to gather information such as radio-frequency identification (RFID) or other near field communication (NFC) technologies.

The one or more QR codes 130 may be typically scanned by first photographing the one or more QR codes 130 using a camera 134 from a mobile device, such as a smartphone 124 or the like. The image is then interpreted by a QR code reader 132 that users install or download, when they install or download the disclosed application, to their mobile device. The QR code reader 132 may decode the QR code 130 to perform an operation based on the QR code 130. The encoded data contains a link to the mobile application site the reader downloaded from a marketplace application such as Google Play or the Apple App Store. The content represented by one of the one or more QR codes 130 is a hyperlink, and the associated action is to launch the device's web browser and visit the website specified by the one or more QR codes 130.

The system 100 realizes the ease with which QR codes 130 may be created and distributed has attracted scammers seeking to direct people to phishing websites. Phishing is a semantic attack that cons individuals, under the guise of a legitimate organization or individual, into visiting a malicious website or providing sensitive information. An attacker might place a sticker of a QR code 130 containing malicious content over a legitimate QR code 130 or create an entirely new QR code 130 advertisement masquerading as a legitimate entity. The QR code 130 may be disposed on a retail item 136 or the like.

A typical QR code 130 use case involves a scan and a click. Perceptive and security-conscious users may pause to examine the hyperlink but, in general, there is very little explicit interaction with the encoded data. The use of shortened Uniform Resource Locators or URLs and the limited screen space of smartphones further obscures browser-based cues.

To address these vulnerabilities, the mobile application will implement a sanity check scan which will verify that the QR code 130 was indeed produced by the system 100. If the scan of the bar code comes back negative the application will return the error message “Please use a valid QR bar code”. The user may also be directed to a website explaining phishing and other security issues and instructed to inform the shops proprietor about the fake QR code. Once the verification check has been completed the user will be able to access the QR code scanned information.

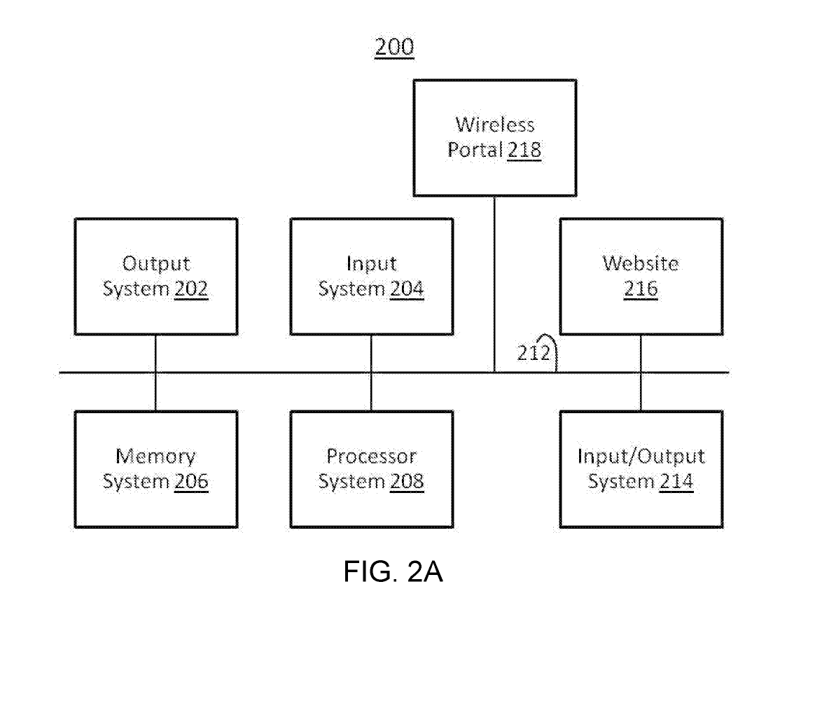

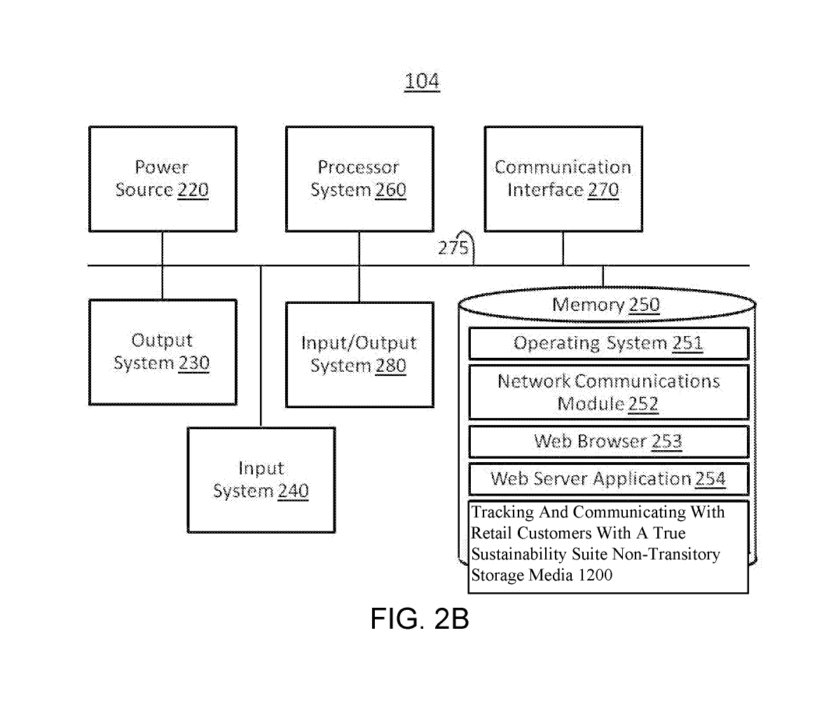

FIG. 2A illustrates a block diagram of a client system 200 that may be utilized as one of the system units for communicating with retail customers with a sustainability standard. The client system 200 may include an output system 202, an input system 204, a memory system 206, a processor system 208, a communications system, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120; handheld or mobile wireless device 122; and/or smartphone 124 that may be utilized as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, an intranet, and/or the Internet.

The input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB). The memory system 206 may include any one of, some of, any combination of or all of a long term storage system such as: a hard drive, a short term storage system such as a random access memory, a removable storage system such as a floppy drive or a removable drive, and/or flash memory. The memory system 206 may include one or more machine readable mediums that may store a variety of different types of information. The term machine readable medium may be utilized to refer to any medium that may be structurally configured for carrying information in a format that may be readable by a machine. One example of a machine-readable medium may be a computer-readable medium. The memory system 206 may store a non-transitory storage media for communicating with retail customers with a sustainability standard.

The processor system 208 may include any one of, some of, any combination of, or all of multiple parallel processors, a single processor, a system of processors having one or more central processors and/or one or more specialized processors dedicated to specific tasks. The processor system 208 may implement the programs stored in the memory system 206. The communications system may communicatively link the output system 202, the input system 204, the memory system 206, the processor system 208, and/or the input/output system 214 to each other. The communications system may include any one of, some of, any combination of, or all of one or more electrical cables, fiber optic cables, and/or means of sending signals through air or water (e.g. wireless communications), or the like. Some examples of means of sending signals through air and/or water may include systems for transmitting electromagnetic waves such as infrared and/or radio waves and/or systems for sending sound waves.

The input/output system 214 may include single devices that function as both input and output devices. For example, the input/output system 214 may include one or more touch sensitive screens which display an image and therefore may be an output device and accept input when the screens are pressed by a finger or a stylus. The touch sensitive screens may be sensitive to heat, capacitance and/or pressure. One or more of the input/output devices may be sensitive to a voltage or a current produced by a stylus. The input/output system 214 is optional, and may be utilized in addition to or in place of the output system 202 and/or the input device 204.

The client systems 110, 114, 116, 118, 120 and the handheld wireless device 122 may also be tied into a website 216 or a wireless portal 218 which may also be tied directly into the communications system. Any website 216 or wireless portal 218 may also include a non-transitory storage media and a website module (not shown) to maintain, allow access to, and run the website.

FIG. 2B illustrates a block diagram of a server system 104 that may be utilized for communicating with retail customers with a sustainability standard. The server system 104 may include a power source 220, an output system 230, an input system 240, a memory system 250, which may store an operating system 251, a communications module 252, a web browser module 253, a web server application 254 and a communicating product and source information with retail customers with a sustainability standard using non-transitory storage media 1200. The server system 104 may also include a processor system 260, a communications interface 270, a communications system and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB).

The memory system 250 may include any one of, some of, any combination of, or all of a long term storage system such as a hard drive, a short term storage system such as random access memory, or a removable storage system such as a floppy drive or a removable drive and/or a flash memory. The memory system 250 may include one or more machine readable mediums that may store a variety of different types of information. The term machine readable medium may be utilized to refer to any medium capable of carrying information that may be readable by a machine. One example of a machine-readable medium may be a computer-readable medium such as a non-transitory storage media. The memory system 250 may store one or more machine instructions for communicating with retail customers with a sustainability standard. The operating system 251 may control all software or non-transitory storage media and hardware of the system 100. The communications module 252 may enable the server system 104 to communicate on the communications network 112. The web browser module 253 may allow for browsing the Internet. The web server application 254 may serve a plurality of web pages to client systems that request the web pages, thereby facilitating browsing on the Internet.

The processor system 260 may include any one of, some of, any combination of, or all of multiple parallel processors, a single processor, a system of processors having one or more central processors, and/or one or more specialized processors dedicated to specific tasks. The processor system 260 may implement the machine instructions stored in the memory system 250.

In an alternative embodiment, the communication interface 270 may allow the server system 104 to interface with the network 112. In this embodiment, the output system 230 may send communications to the communication interface 270. The communications system communicatively links the output system 230, the input system 240, the memory system 250, the processor system 260 and/or the input/output system 280 to each other. The communications system may include any one of, some of, any combination of, or all of one or more electrical cables, fiber optic cables, and/or sending signals through air or water (e.g. wireless communications), or the like. Some examples of sending signals through air and/or water may include systems for transmitting electromagnetic waves such as infrared and/or radio waves and/or systems for sending sound waves.

The input/output system 280 may include devices that function both as input and output devices. For example, the input/output system 280 may include one or more touch sensitive screens. These screens not only display an image and therefore are an output device they also accept input when the screens are pressed by a finger or a stylus. The touch sensitive screens may be sensitive to heat and/or pressure. One or more of the input/output devices may be sensitive to a voltage or a current produced by a stylus. The input/output system 280 may be optional and may be utilized in addition to or in place of the output system 230 and/or the input device 240.

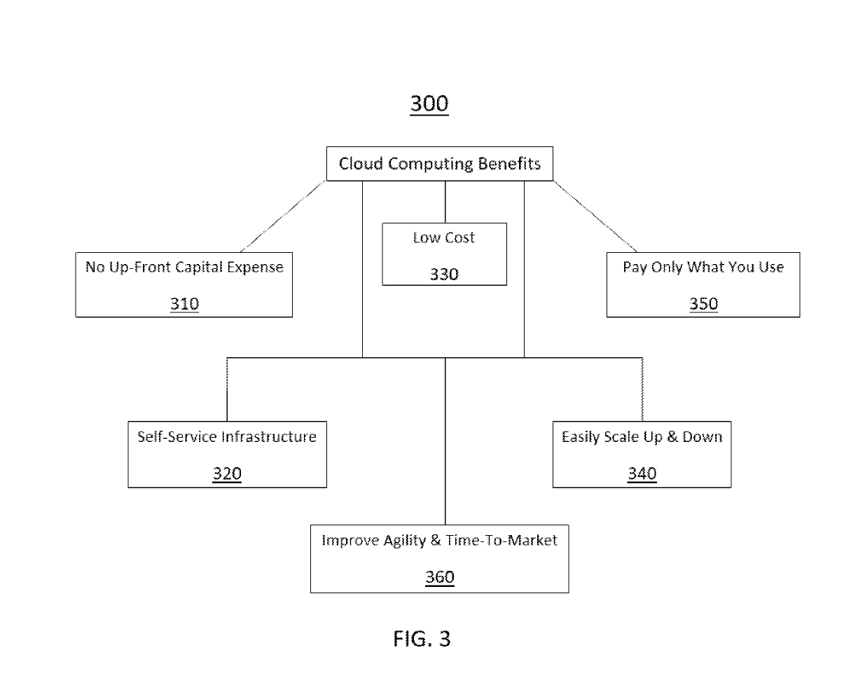

FIG. 3 illustrates a diagram describing a plurality of cloud computing benefits 300.

The cloud computing benefits 300 may include a no up-front capital expense icon 310, a low cost icon 320, a pay only for what you use icon 330, a self-service infrastructure 340, a easily scale-up and down icon 350 and an improve agility and time to market icon 360.

Amazon launched Amazon Web Services or AWS or the like may be the cloud computing platform for the system 100. The system 100 may benefit from Amazon's experience and investment in running a large-scale distributed, transactional IT infrastructure. AWS has been operating since 2006, and today serves hundreds of thousands of customers worldwide. Amazon.com runs a global web platform serving millions of customers and managing billions of dollars' worth of commerce every year. Using AWS, the system 100 may be able to leverage computer power, storage, and other services in minutes and may have the flexibility to choose the development platform or programming model.

Cost is one of the most complex elements of delivering contemporary IT solutions. It may be that for every advance that will save money, there is often a commensurate investment needed to realize that savings. For example, developing and deploying an e-commerce application may be a low-cost effort, but a successful deployment may increase the need for hardware and bandwidth. Furthermore, owning and operating an infrastructure may incur considerable costs, including power, cooling, real estate, and staff.

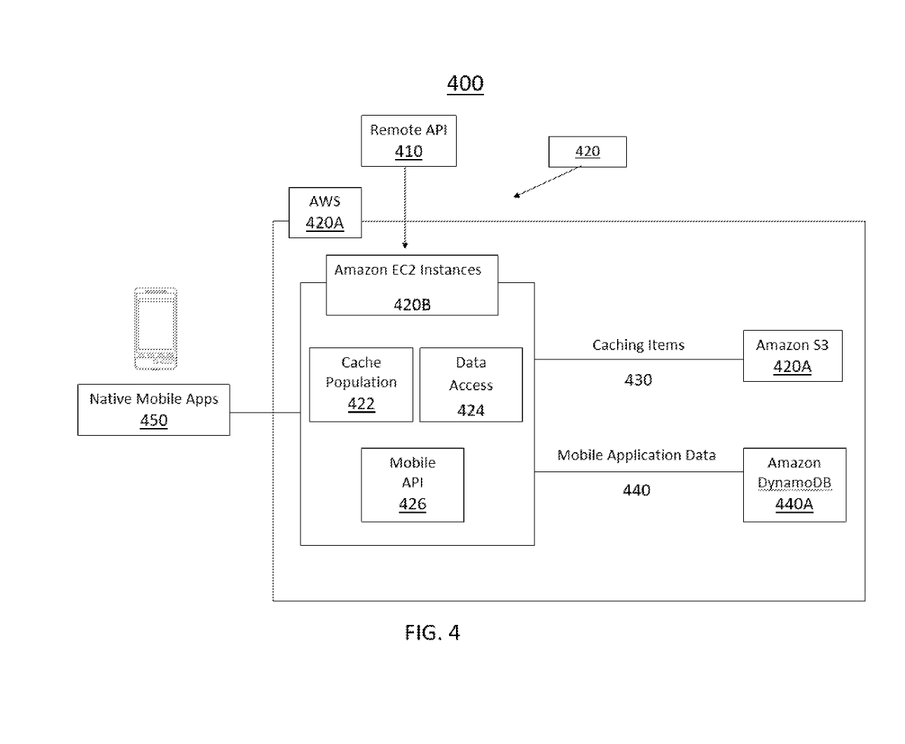

FIG. 4 illustrates a diagram of an initial mobile application architecture 400.

The initial mobile application architecture 400 may include a remote application programming interface or API 410, a website service 420, one or more caching items 430, a plurality of mobile application data 440 and one or more native mobile apps 450.

The remote API 410 may include a remote procedure call or RPC mechanism (not shown) in which a pocket personal computer or PC (not shown) is the server and a PC application is the client. The website service 420 may be an Amazon website service 420A or the like. The Amazon website service 420A may be one or more of Amazon Elastic Compute Cloud or Amazon EC2 instances 420B that may be one or more virtual servers in Amazon's EC2 for running applications on the Amazon web services or AWS infrastructure. The Amazon website service 420A may include a cache population file 422, a data access file 424 and a mobile application programming interface or mobile API 426. The one or more caching items 430 may be in communication with the website service 420. The one or more caching items 430 may reside on Amazon Simple Storage Service or S3 420A or the like. The mobile application data 440 may be in communication with the website service 420. The mobile application data 440 may reside on an Amazon Dynamo database 440A or the like. The one or more native mobile apps 450 may be a smartphone application that is coded in a specific programming language, such as Objective C for a mobile operating system or iOS™ or JAVA™ for a mobile or ANDROID™ operating system and the like. Native mobile apps may provide relatively faster performance and a relatively higher degree of reliability. They also have access to a smartphone with various devices, such as its camera and address book (both not shown). In addition, users may use some apps without an Internet connection. However, one or more native mobile apps 450 may be relatively expensive to develop because it is tied to one type of operating system, forcing the company that creates the native mobile apps 450 to make duplicate versions that work on other platforms.

AWS delivers a scalable cloud-computing platform that provides customers with end-to-end security and end-to-end privacy. AWS builds security into its services in accordance with security best practices, and documents how to use the security features. AWS takes the following approaches to secure the cloud infrastructure. AWS has in the past successfully completed multiple SAS70 Type II audits, and now publishes a Service Organization Controls 1 or SOC 1 report, published under both the SSAE 16 and the ISAE 3402 professional standards. In addition to the SOC 1 report, AWS publishes a Service Organization Controls 2 or SOC 2, Type II report. Similar to the SOC 1 in the evaluation of controls, the SOC 2 report is an attestation report that expands the evaluation of controls to the criteria set forth by the American Institute of Certified Public Accountants or AICPA Trust Services Principles.

Top-of-the-line security is paramount when protecting sensitive information. Bank-level security means that important company information is encrypted and protected using the same industry-leading technology that banks use.

Within the system 100, all data is stored using Advanced Encryption Standard or AES-256 encryption with a uniquely derived key for each user following the recommendations of National Institute of Standards and Technology or NIST Special Publication 800-132. Every single personally identifiable field in the database is encrypted, including the name and the e-mail address. For searching and indexing, a small number of fields are hashed using Hashed Message Authentication Code or HMAC.

All communications between a company and the system 100 will be encrypted via Secure Sockets Layer or SSL using 2048-bit certificates and required SSL on all communications. Perfect forward secrecy is used so that even if someone eavesdrops on communication, they will still not be able to decrypt the data in the event that the key is compromised.

The system 100 follows best suitable practices to keep data secure. In addition to severely restricting access to operational environments (including private keys), we regularly audit our environments and code for security issues and apply patches expeditiously.

Because security and privacy is paramount, we limit what access our administrators have to an account to the limited set of data necessary to help grant access to an account (by triggering confirmation emails, for example) and help restrict access to an account in urgent circumstances. They may have access to limited meta-data (such as whether or not a will is uploaded) but not the data itself (they will never be able to see the will uploaded). The system 100 logs and regularly audits all accesses to an account, whether by you, an administrator or deputies.

The system 100 may base a minimum viable product or MVP mobile commerce strategy for developing this application.

The system 100 may make navigation as simple as possible by focusing on the user experience. This may include an intuitive search and browsing as well as an easy check out process.

The system 100 may develop a native app that increases responsiveness and speed of the native app delivering the best user experience for the user. However, besides the native app, the mobile web site is core to reach and to cover all platforms. The system 100 may also increase security.

The system 100 may partner with experienced mobile developers and consultants that will have past experiences of success to build on, using their experience to save time, avoid failure, gain on quality and have a faster Return on Investment or ROI. The system 100 may encourage social interaction by including sharing options on social networks. The system 100 may use analytics to track key performance indicators and efficiently manage an m-commerce project.

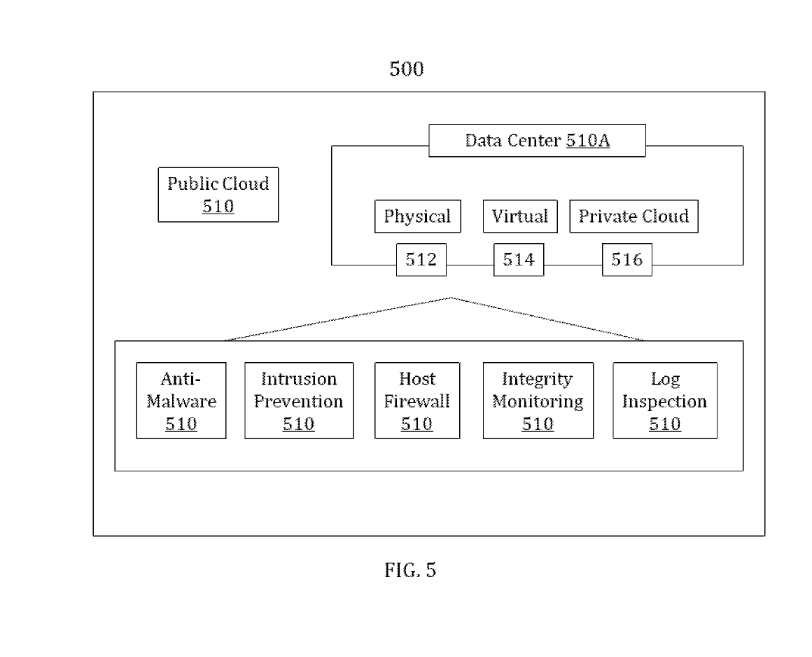

FIG. 5 illustrates a diagram of a single integrated Admin console 500.

The single integrated Admin console 500 may include a public cloud 510 and a comprehensive set of security capabilities.

The public cloud 510 may include a data center 510A or the like. The data center 510A may include a plurality of physical data 512, a plurality of virtual data 514 and a private cloud 516. The comprehensive set of security capabilities may include anti-malware 510, intrusion protection 510, a host firewall 510, integrity monitoring 510 and a log inspection 510.

The single integrated Admin console 500 may implement a malware Deep security platform solution on all AWS servers. The benefits will include:

Comprehensive security capabilities, including anti-malware with web reputation, host-based firewall, intrusion detection/prevention, integrity monitoring, log inspection, and globally trusted SSL certificates.

Deployment flexibility with the choice of software or non-transitory storage media or as service offerings. Full multi-tenant capabilities for easy service operation. Reduced cost and complexity with a single platform for management of security controls and policies across multiple environments: physical, virtual, cloud, and hybrid.

This Deep Security solution protects the systems enterprise mobile application and prevents data breaches and business disruptions without requiring emergency patching. This comprehensive, centrally managed platform helps the system simplify security operations while enabling regulatory compliance and accelerating the ROI of virtualization while leveraging the cloud.

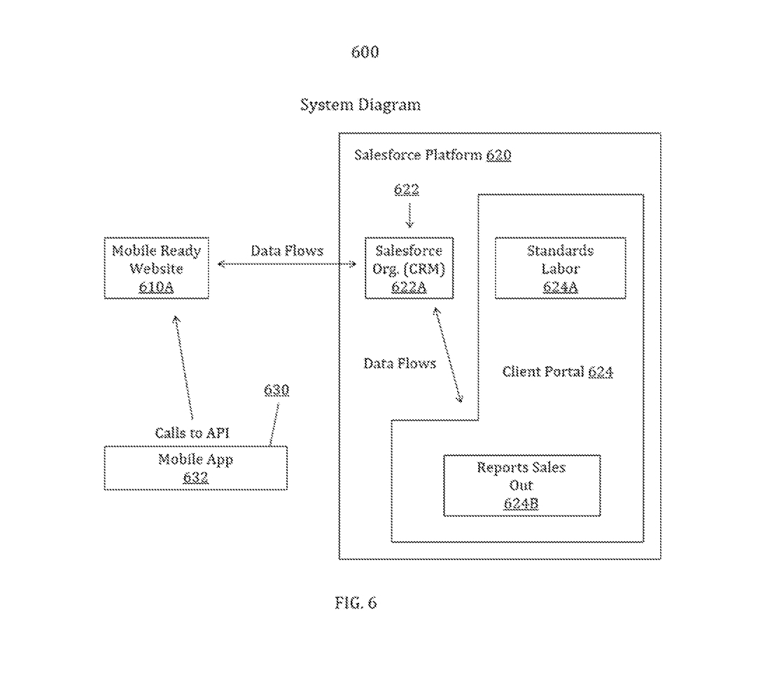

FIG. 6 illustrates an overall system diagram 600.

The overall system diagram 600 may include a website 610A, a salesforce platform 620 and a mobile app 630.

The website 610A may be a mobile ready website 610A or the like. The Salesforce® platform 620 may include a salesforce organization 622 and a client portal 624. The salesforce organization 622 may be instead any customer relations management or CRM 622A or the like. The client portal 624 may include a plurality of web forms 624A for standard data submission or the like. The client portal 624 may include a plurality of web-based reports 624B to provide data to the client or the like. Data may be collected by the client portal 624 or any of the web forms 624A by either automatic input (from social media for example) or through input by user. The data is comprised of: customer demographic information, customer preferences, shopping habits, reviews of products, frequency of shopping, amount spent, and any social “likes” or indicators of positive or negative reactions to marketing or the retail experience. This data may be partitioned into various types, analyzed and then marketed and sold to the retail, wholesale or entity in the supply chain.

The data may flow from the client portal 624 to the salesforce organization 622 and from the salesforce organization 622 to the client portal 624. The data may also flow from the salesforce platform 620 to the website 610 and from the website 610 to the salesforce platform 620. The website 610 may include cached content from the salesforce organization 622 about products and user management or the like. The mobile app 630 may be in communication with the website 610 and may call to an application programming interface or API 632 or the like.

The product and supply-chain or source information regarding the product or good is available to the customer immediately as the customer is browsing for an item at the retail outlet or at the point of sale when they scan the QR or similar scan-able code common in the art to trigger a client portal for viewing the product and source information. The data about the product or good may be updated at or near real-time or alternatively periodically from the product/supply chain. The data is then transported and alternatively saved in the user's customized client portal 624.

The data provided to the customer at real-time, near-real time or periodically at the retail outlet may then be analyzed and compared to custom sustainability standards. The sustainability standard provides a unique perspective of each good and product and may provide data to the customer about how each entity ranks on a wide set of indices. This supply chain data is compared to the registry standards which is comprised of rankings for the product or good's origin including the labor that went into its creation, how it was manufactured, the facility the labor took place in, and/or the environmental impact. This data provides dynamic and relational data to the customer, retail outlet and other users of how the source of the product or good is ranked compared to a sustainability standard.

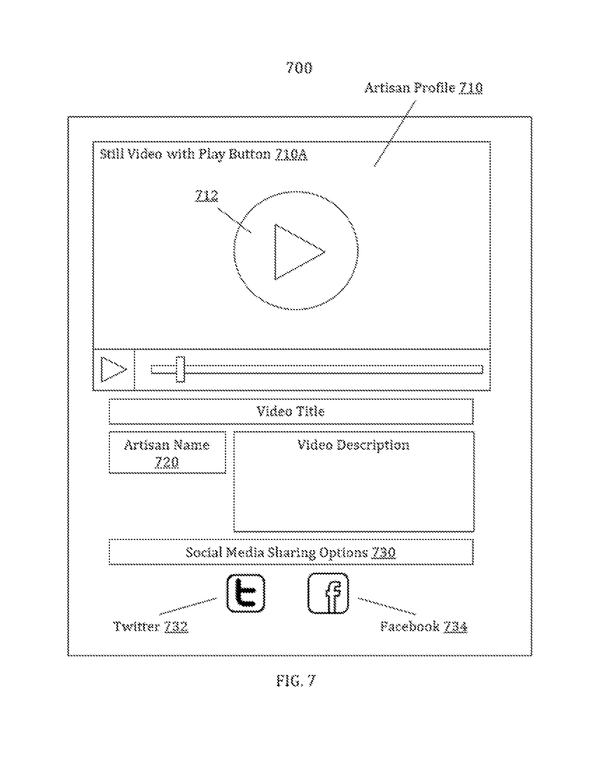

FIG. 7 illustrates an artisan profile screenshot 700. The artisan profile represents and/or actually is the person or group of people who manufactured or crafted the good being purchased at point of sale. Manufactured or crafted may mean any range of activity from actually hand-making the item with a tool pallet or operating a machine that physically creates the valuable good.

The artisan profile screenshot 700 may include a video display 710, an artisan description 720 and one or more social media links 730.

The video display 710 may include a play button 712 to play a video such as a plurality of video stills 710A or the like. The artisan description 720 may provide information about the artisan. The one or more social media links 730 may enable communication of the artisan profile screenshot 700 and a social media user. The one or more social media links 730 may include a social networking service that enables users to send and read short messages or TWITTER® link 732 and an online social networking service or FACEBOOK® link 734.

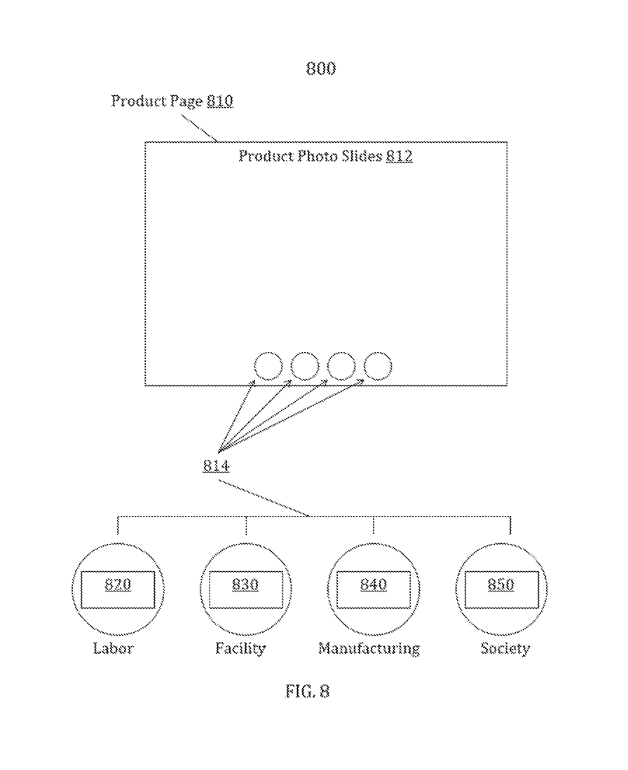

FIG. 8 illustrates a product page screenshot 800.

The product page screenshot 800 may include a product photo slider 810, a labor icon 820, a facility icon 830, a manufacturing icon 840 and a society and environmental icon 850.

The product photo slider 810 may include a pair of directional arrows 812 and a plurality of indicator lights 814. The product photo slider 810 may display multiple views of the product and possibly multiple views of production of the product and sales pamphlets and the like. The labor icon 820 may include a description of one or more locations and ranking of the laborers of the product. The facility icon 830 may include a description of one or more of the facilities making the product. The manufacturing icon 840 may include a description of one or more of the products being manufactured and a ranking of the product(s) being manufactured. The manufacturing icon 840 may also include a description of the standards and details of the product(s) being manufactured. The society and environmental icon 850 may include a description of the societal and environmental impacts from the product.

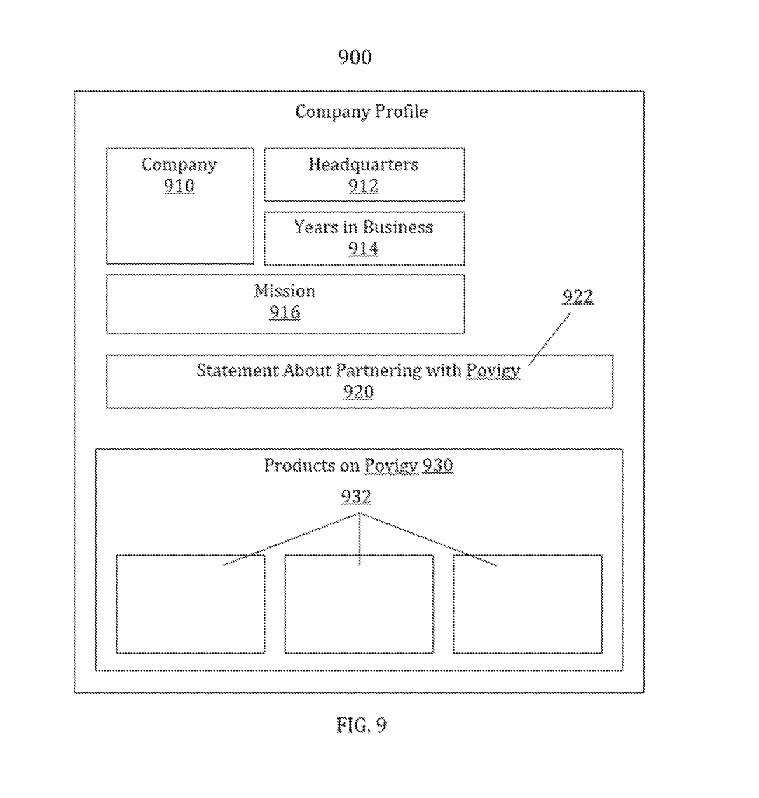

FIG. 9 illustrates a company profile screenshot 900.

The company profile screenshot 900 may include a company description 910, a partnering statement 920 and one or more product displays 930. The company description 910 may include a company name 912, a number of years in business 914 and a mission description 916. The partnering statement 920 may include a statement about partnering with Povigy 922. The one or more product displays 930 may include one or more product displays on Povigy 932.

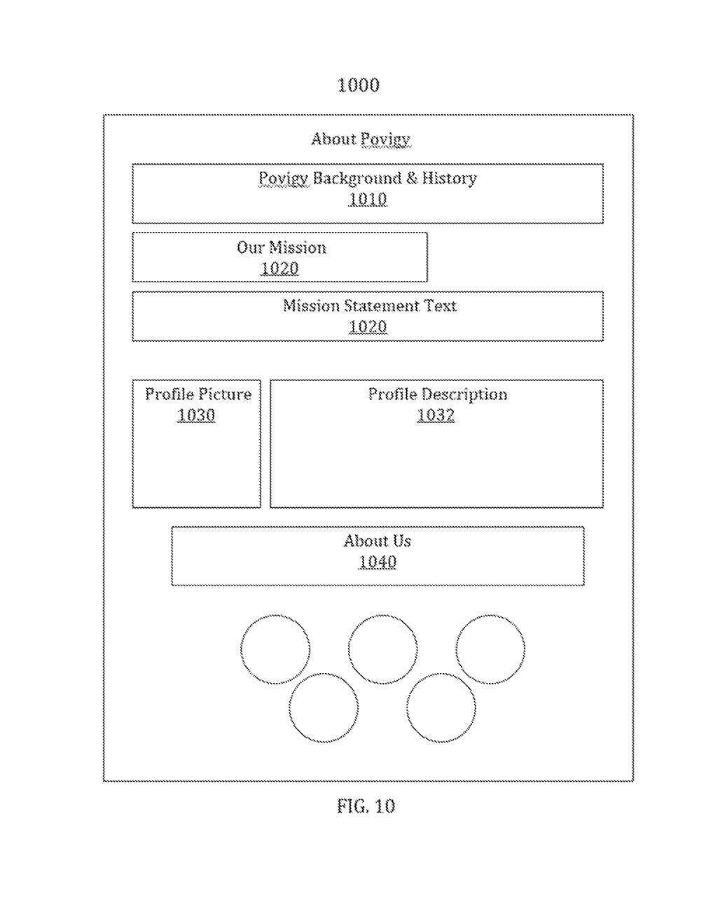

FIG. 10 illustrates an about Povigy screenshot 1000.

The about Povigy screenshot 1000 may include a founding statement 1010, a mission statement 1020, an executive digital photo 1030 and a plurality of employee digital photos 1040.

The founding statement 1010 may describe how Povigy was founded. The mission statement 1020 may be Povigy's mission statement. The executive digital photo 1030 may include a background description 1032 of the executive in the executive digital photo 1030. The employee digital photos 1040 may be disposed underneath the executive digital photo 1030 on the about Povigy screenshot 1000.

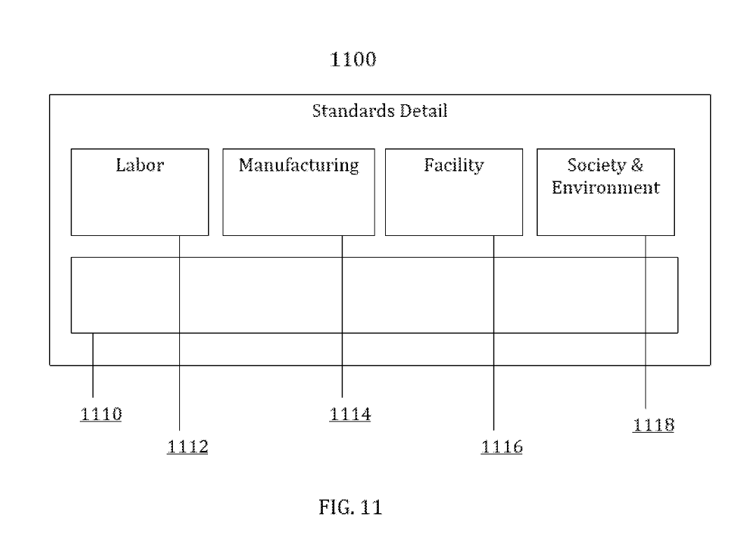

FIG. 11 illustrates a standards detail screenshot 1100.

The standards detail screenshot 1100 may include a description of a plurality of sustainability standards 1110.

The description of sustainability standards 1110 may include a description of labor standards 1112, a description of manufacturing standards 1114, a description of facility standards 1116 and a description of environmental standards 1118. Each registry standard has sub-categories which are kept up to date in either real-time, near-real time or periodically refreshed to provide the customer the latest information on the product they are about to purchase. These standards may be used to score a product or good on a scale, which may be from 1-4, with 4 being the best or highest. The client/customer may take that information and use it for their purchase decision and may provide data to the client portal 624 about their decision making process. This data then may be collected, stored, analyzed and then licensed or sold to a third party marketing company or other customer of data. Use of this data may be for many advertising purposes comprising: targeted mailing, electronic mailing, market analysis, point of sale promotions, or printed advertising, among others.

The Environmental standard 1118 is further comprised of rankings based on: energy consumption, water consumption, waste management, emissions, post-consumer recycling, environmental considerations, technology improvements, raw materials, packaging materials and shipping materials.

The Facility Standard 1116 is further comprised of rankings based on: Building Permits, Building Occupancy, Building construction type, means of egress, Number of Exits, Building Ventilation, Housekeeping, Toilet, bathing and drinking water, Dormitory, and Break Areas.

Labor Standard 1112 is further comprised of rankings based on: child labor, forced labor, regular working hours, overtime working hours, weekly break, leave from work, daily wages, additional days off, worker flexibility and recognition, and job creation

Manufacturing Standard 1114 is further comprised of rankings based on: hazardous materials, walking and working surfaces, particulate control, noise exposure, illumination, production risk management, maintenance plan, employee training exposure, first aid, and ergonomics.

Taken together, the data related to the customer provides a very clear picture of how sustainable the product they are about to purchase is and in general, how their purchase is affecting the people, environment and society around them.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A system for communicating product and source information with retail customers with a sustainability standard, comprising:
a server system with a processor system, a communications interface, a communications system, an input system and an output system, the server system having access to a communications network;
a memory system with an operating system, a communications module, a web browser module, and a web server application.
a code disposed on a retail item, the code is scanned by a code reader, the code reader may decode the code to perform an operation based on the code; and
a website with a plurality of web pages for communicating with retail customers with one or more sustainability standards.

2. The system for communicating product and source information with retail customers with a sustainability standard of claim 1, wherein the code is a quick response code.

3. The system for communicating product and source information with retail customers with a sustainability standard of claim 1, where the code could be any near field communication device wherein the code reader and the code need to come within a predetermined distance for the code reader to decode the code.

4. The system for communicating product and source information with retail customers with a sustainability standard of claim 1, wherein the code permits the locations of the associated product to be determined.

5. The system for communicating product and source information with retail customers with a sustainability standard of claim 1, wherein the code contains a description of multiple standards related to the product.

6. The system for communicating product and source information with retail customers with a sustainability standard of claim 5, wherein the standards comprise at least labor standards, manufacturing standards, facility standards, or environmental standards.

7. A computer program product for communicating product and source information with retail customers with a sustainability standard, the product comprising:
one or more computer readable storage media and program instructions stored on the one or more computer readable storage media, the program instructions comprising:
program instructions to receive information associated with a product within a cloud computing system;
program instructions to store the information associated with a product within the cloud computing system;
program instructions to receive a request from a customer about the information associated with the product;
program instructions to provide the customer with a portion of the information associated with the product; and
program instructions to compare the portion of the information associated with the product provided to the customer to similar goods.

8. The computer program product for communicating product and source information with retail customers with a sustainability standard, of claim 7 further comprising;
program instructions to store the analyzed information.

9. The computer program product for communicating product and source information with retail customers with a sustainability standard, of claim 7 further comprising;
program instructions to allow the retail customer to share the portion of information associated with the product with other people.

10. The computer program product for communicating product and source information with retail customers with a sustainability standard, of claim 7 further comprising;
program instructions to select a portion of the stored information to analyze associated with predetermined factors.

11. The computer program product for communicating product and source information with retail customers with a sustainability standard, of claim 7 further comprising;
program instructions to connect a retail customer with a product via near field communication, wherein the near field communication device is part of the product packaging.

12. The computer program product for communicating product and source information with retail customers with a sustainability standard, of claim 7 further comprising;
program instructions to connect a retail customer with a product via a quick response code, wherein the response code is part of the product packaging.

13. The computer program product for communicating product and source information with retail customers with a sustainability standard, of claim 7, wherein the program instructions to provide the customer with a portion of the information associated with the product occurs at a predetermined interval.

14. A computer system for communicating product and source information with retail customers with a sustainability standard, the system comprising:
one or more computer processors, one or more computer readable storage media, and program instructions stored on the one or more computer readable storage media for execution by at least one of the one or more processors, the computer instructions comprising:
program instructions to receive a plurality of information associated with a product within a cloud computing system;
program instructions to store information associated with a product within the cloud computing system;
program instructions to receive a request from a customer about information associated with the product;
program instructions to provide the customer with a portion of information associated with the product; and
program instructions to compare the portion of information associated with the product provided to the customer to similar goods.

15. The computer system, of claim 14 further comprising;
program instructions to store the analyzed information.

16. The computer system, of claim 14 further comprising;
program instructions to allow the retail customer to share the portion of information associated with the product with other people.

17. The computer system, of claim 14 further comprising;
program instructions to select a portion of the stored information to analyze associated with predetermined factors.

18. The computer system, of claim 14 further comprising;
program instructions to connect a retail customer with a product via near field communication, wherein the near field communication device is part of the product packaging.

19. The computer system, of claim 14 further comprising;
program instructions to connect a retail customer with a product via a quick response code, wherein the response code is part of the product packaging.

20. The computer system, of claim 14 further comprising;
program instructions to provide the customer with a portion of the information associated with the product occurs at a predetermined interval.
